(19) United States
(12) Patent Application Publication
(10) Pub. No.: US 2011/0252989 A1
(43) Pub. Date: Oct. 20, 2011

(54) Automatic Axis Correction Method for Use in a Processing Machine for Processing a Product Web

(75) Inventors: Stephan Schultz, Lohr-Wombach (DE); Holger Schnabel, Veitshoechheim (DE)

(73) Assignee: Robert Bosch GmbH, Stuttgart (DE)

(21) Appl. No.: 13/126,148

(22) PCT Filed: Sep. 1, 2009
(86) PCT No.: PCT/EP2009/006313

§ 371 Date: Jun. 22, 2011

(30) Foreign Application Priority Data
Oct. 27, 2008 (DE) 10 2008 053 406.4

(51) Int. Cl. B41F 13/02; B65H 23/10

(52) U.S. Cl. 101/228; 242/410; 226/195

(57) ABSTRACT

A method for automatic axis correction in a processing machine for processing a product web, wherein the product web is subdividable into at least two web tension sections, a web tension section being delimited by two clamping points formed as transport or processing devices. An axis deviation of at least one clamping point formed as a processing device is determined. The at least one clamping point is then opened, the axis thereof is automatically corrected on the basis of the axis deviation determined and the clamping point is closed after the axis correction.

The present invention relates to a method for automatic axis correction in a processing machine for processing a product web, a corresponding computer program and a corresponding computer program product.

Although, in the following text, reference is primarily made to printing presses, the invention is not restricted thereto but instead is directed to all types of processing machines in which a product web or material web is processed. However, the invention can be used in particular in printing presses, such as newspaper presses, jobbing presses, gravure presses, packaging presses or valuable-document presses and also in processing machines such as bag-making machines, envelope-making machines or packaging machines. The product web can be formed from paper, material, paperboard, plastic, metal, rubber, in the form of film and so on.

### PRIOR ART

In relevant processing machines, in particular in printing presses, a product web is moved along driven axes (web transport axes or web transport devices), such as pull rolls or feed rolls, and non-driven axes, such as deflection, guide, drying or cooling rolls. The product web is simultaneously processed by means of usually likewise driven processing devices, for example printed, punched, cut, folded and so on. The driven axes influence both the web tension and the respective longitudinal deviation of individual processing devices, for example a color register or longitudinal register.

In the case of multicolor printing in rotary presses, the application of the individual color separations, in particular for cyan, magenta, yellow and black, is carried out in successive printing units. The printing material is provided in this case as roll material and led continuously through the printing unit. It is critical for the printing quality achieved that the printed images of the individual colors lie one above another. The superimposition of the printed images is designated as register. For the purpose of mutual alignment of the individual printing units, in addition to the actual printed image, register measuring marks, for example in the form of register crosses, are printed on by each printing unit. By using these marks, an offset between the individual printed images can be registered online by an optical measuring system. In rotary printing systems, this measuring system is generally a constituent part of a control system, what is known as the register controller. The register controller intervenes in the printing process via suitable actuating elements and compensates for detected register deviations.

The cause of deviations between the individual prints is, in addition to the relative position of the printing units in relation to one another, changes in the geometry of the printing material. These geometric changes are brought about, for example, by the influence of moisture or by drying devices arranged between the printing units.

It is desired to keep the web tension as constant as possible during the printing process, which permits good printing quality without substantial corrections. The controller parameters of the register controller are matched to this operating state, by which means the controller is automatically able to control out register errors that occur.

As opposed to this, a control system for pre-setting a register at the start of the printing process (prior registering) has previously not existed. According to the prior art, pre-registration is carried out manually by the printer.

In the case of a gravure printing press, a clamping point is normally defined by a printing unit, in which there is a frictionally induced unit between the driven printing cylinder, a back-pressure roll, the impression roll and the material web. Further clamping points are formed by the infeed and outfeed units of the printing press. In this way, the product web can be subdivided into web tension sections, a web tension section being delimited by two clamping points. Following a machine start, according to the prior art, first of all the impression roll of the first printing unit and of the second printing unit are thrown on by the printer or printers and in this way a web tension section is formed between the two printing units. The printer waits until a steady state has been achieved, i.e. until the web tension or the register is still changed by external influences but no longer on account of a dynamic transient. He then reads the current register deviation or axis deviation, which is measured by means of sensors or by means of a camera system. This axis deviation is generally relatively large, so that the printer throws off the impression roll of the second printing unit, adjusts the second printing cylinder manually and then throws the impression roll on again. A wait is then made for a steady web tension state again. Following this equalization time, which depends on the machine speed and the web length between the printing units, fine adjustment of the register of the first two printing units can then be carried out. This procedure must be repeated by the printer for all the following printing units. Depending on the number of printing units present, this can result in a very long setup time.

The disadvantage with this method according to the prior art is that the setting up is carried out manually by the printer, who additionally has to read the value for the coarse registration inaccurately from a display device. Furthermore, the printer has to wait until the steady machine state is reached again in each case. This can lead to the situation where, for example on account of erroneous reading or hurrying, the pre-registration of downstream printing units is begun even before the steady state of an upstream printing unit has been reached, and therefore the pre-registration has to be started again. During the entire setup time, rejects (waste paper) are produced.

There is a similar situation when, during a normal processing operation, considerable register deviations occur (e.g. as a result of speed changes). As a result of the dynamic compensation operations, such a defect is propagated downstream and it can take a very long time until the error has been controlled out.

The invention is therefore based on the object of improving and/or accelerating the axis correction of processing devices of a web-processing machine, in particular a web-processing printing press.

This object is achieved by a method for automatic axis correction in a processing machine for processing a product web, in particular in a shaftless printing press, a computer program and a computer program product having the features of the independent patent claims. Advantageous developments are the subject matter of the subclaims and of the following description.

Automatic axis correction can be carried out in a processing machine for processing a product web, in particular in a shaftless printing press, the product web being subdividable into at least two web tension sections, a web tension section being delimited by two clamping points formed as transport or processing devices. An axis deviation of at least one clamping point formed as a processing device is determined, the at least one clamping point is then opened, the axis thereof is automatically corrected on the basis of the axis deviation determined and said clamping point is closed after the axis correction.

### Advantages of the Invention

The invention provides a method for axis correction in which axes can be corrected substantially in parallel, for example during pre-registration, automatically without any manual adjustment. As compared with corresponding manual serial methods in the prior art, this leads to a significant saving in time and, as a result, to a considerable reduction in rejects. In addition, even during normal production operation, in particular large axis deviations can be corrected quickly by opening the clamping point, which likewise leads to a significant saving in time and, as a result, to a considerable reduction in rejects.

According to a particularly preferred refinement, the at least one clamping point is opened after a steady state or product web transport state has been reached. Once a steady state has been reached, the web tension or the register is only changed further by external influences (disruptions). The dynamic transient has been concluded. As a result of this measure, it is possible in particular to prevent temporary axis deviations being used as a basis for a correction.

Advantageously, the determination of the steady state is carried out by incorporating monitoring of the web tension, in particular by means of force measurement or web tension measurement, web tension calculation (for example by means of observing other parameters) and/or by monitoring a register. The register monitoring can in particular be carried out optically. Advantageously, the determination of the achievement of the steady state is carried out by means of existing measurement technology such as sensors or cameras. Furthermore, monitoring of the web tension can be carried out by means of force transducers or by observation. In particular, provision can be made, in this connection, for example to provide register marks on the product web, by means of which a register deviation can be detected in a simple and fast way. If the web tension and/or the register move within a predefined range over a predefined time period, i.e. only small fluctuations occur, a steady state can be assumed.

Expediently, in addition—expediently after the steady state has been reached—in each case an axis deviation of all the clamping points formed as a processing device downstream of the at least one clamping point is determined. The downstream clamping points are opened, the axes thereof are corrected automatically, in each case on the basis of the axis deviation determined, and said clamping points are closed after the axis correction.

In particular in the refinement just explained, the method can advantageously be carried out for the automatic pre-registration of a processing machine but provision can also be made to carry out the method during continuous operation, for example if an axis deviation or register error exceeds a predetermined value and can no longer be compensated in good time by means of a normal control system or the latter appears disadvantageous. To this end, appropriate assessment criteria can be used.

Advantageously, the method for automatic pre-registration of a processing machine is carried out with the following steps:

In a first step, the product web is clamped in by using a first clamping point and at least one second clamping point, in each case formed as a processing device. At least one web tension section is formed hereby. As a rule, however, in this step all the clamping points, i.e. processing devices and additional infeed and/or outfeed units of a corresponding processing machine, are closed. The closing of the clamping points can be carried out simultaneously or successively with the machine at a standstill or at a low speed. A wait is preferably then made until a steady state has been reached. As already explained above, a steady state has been reached when the web tension and the register still fluctuate only on account of external influences or disruptions but no longer change on account of a dynamic transient. An axis deviation of the at least one second clamping point is then determined. The at least one second clamping point is preferably all downstream clamping points formed as a processing device. The values determined can initially be provided in the system or within a controller, actuating values for the axis correction usually also being determined within the controller. Following this step, the at least one second clamping point is opened and corrected. In this way, a rapid correction on the basis of the previously determined deviation values can advantageously be made and is not delayed by the very long equalization processes which are brought about by closed clamping points. The setting is carried out in particular by using a setting value previously determined in a controller for the corresponding processing device. Following the setting, the product web is clamped in by using the at least one second clamping point. Once, according to the above-described preferred refinement, axis deviations for all the downstream clamping points have been determined, all the other downstream clamping points are correspondingly opened, corrected and closed, it being possible for opening, correction and closing to be carried out simultaneously or successively in each case. The automatic pre-registration is therefore concluded. It should be emphasized once more at this point that at least the correction step proceeds automatically, i.e. by using the mechanically determined axis deviations, within a computing unit, normally a controller, a corrective actuating value is determined, which is applied to the opened clamping point. Preferably, however, the method proceeds automatically, starting at the latest with the determination of the axis deviation.

It is recommended to apply to a clamping point for axis correction an actuating command which is determined on the basis of the axis deviation determined, in particular by a control device. In this way, for example, an angular adjustment, speed adjustment or positional adjustment of the axis can be carried out particularly simply whilst taking the axis deviation into account.

Expediently, the actuating command is additionally determined on the basis of the axis deviation determined for at least one further clamping point. It is recommended that the further clamping point is an upstream one. Furthermore, it is recommended to take all the upstream clamping points into account. In particular in web-processing machines, the adjustment of one clamping point normally affects the following product web region, so that the correction of the downstream axis is advantageously carried out not only by using the axis deviation of this axis but also by using the axis deviation of upstream axes. For example, the upstream axis deviations can be fed to the controller for the relevant clamping point.

Advantageously, the actuating command is cascaded to at least one further clamping point. It is in particular expedient to cascade the actuating command to downstream axes. The cascading can be carried out, for example, as feedforward control, the cascaded actuating command having time-independent factors and/or dynamic time elements applied to it statically. Here, the time elements used can be, for example, PT1, PT2, DT1, DT2 or dead-time elements. In this way, parallel axis correction can be carried out in a particularly advantageous way, in particular within the context of pre-registration. The cascading is advantageously carried out as a function of the chosen control strategy (e.g. reference color, precursor color). Precursor color means that the printed mark of the actual printing unit is compared with the mark from the printing unit located upstream. Therefore, for static decoupling, an adjustment of a printing unit must be cascaded to all following printing units. Reference color means that all the printing units are compared with a fixed mark (as a rule the first mark) and are controlled to the latter. This necessitates other dynamic and static cascading strategies. Furthermore, when incorporating dynamic time elements, in particular pre-setting in the non-static state can also be carried out. Here, setting of a downstream processing unit is possible by the effect of an adjustment of an upstream unit being used as a constant in conjunction with the aforesaid forwarded setting values.

The method according to the invention can be used particularly advantageously in a processing machine constructed as a printing press, the clamping points being formed as infeed units, outfeed units and/or printing units. Here, the method can contribute in a particularly beneficial way to automating the setup time and/or the pre-registration of a corresponding printing press, shortening the time and reducing the production of waste paper. If, during continuous operation of the printing press, the register setting changes to an extent which cannot be compensated for by normal control systems or can be compensated for too slowly, the method according to the invention can be used here for re-registration.

In a preferred printing press, at least one printing unit has a printing cylinder and an impression roll, it being possible for the impression roll to be arranged in a variable from the printing cylinder to open the printing unit. It should be emphasized that there is no closed clamping point in any of the variable distances. Thus, provision can be made to provide for the actuating travel of at least one impression roll to be adjustable and preferably to match it to the printing roll. In the prior art, the impression rolls are normally thrown on pneumatically, only a standard actuating travel being provided, along which the impression roll can be thrown on or off. Conventional impression rolls can be arranged only at a fixed and normally very large distance from the printing cylinder.

Expediently, the impression roll is arranged at a first distance as the printing unit is opened for the purpose of axis correction. Since, in printing presses, different printing cylinder sizes can be used for the respective formats, the actuating travel in the prior art is oriented toward the greatest diameter, and therefore the distance between the printing cylinder and a thrown-off impression roll is considerable in the case of smaller printing cylinders. This leads to a dip in the web tension in the machine as soon as the impression roll is thrown off, since throwing off the impression roll shortens the web travel considerably. According to this preferred refinement of the invention, different movement ranges or distances of the impression rolls depending on the circumference of the printing roll can be used for the purpose that the impression roll is lifted only minimally off the printing cylinder and thus the web travel changes only to a small extent. If a printing cylinder correction is carried out in this machine state, the impression roll can be thrown on again without this resulting in noticeable changes on the material to be printed. This leads to a considerably shortened transient. In the event that the printing unit is opened for a purpose other than for axis correction, the impression roll can then be arranged at a second (large) distance.

The invention additionally relates to a computer program having program code means in order to carry out all the steps of the method according to the invention when the computer program is executed on a computer or an appropriate computing unit, in particular in a processing machine.

The computer program product provided in accordance with the invention, having program code means which are stored on a computer-readable data storage medium, is designed to carry out all the steps of the method according to the invention and, if appropriate, to configure a control loop according to a method according to the invention when the computer program is executed on a computer or an appropriate computing unit, in particular in a processing machine. Suitable data storage media are in particular floppy disks, hard disks, flash memories, EEPROMs, CD-ROMs, DVDs and the like. A download of a program via computer networks (Internet, Intranet and so on) is also possible.

Further advantages and refinements of the invention can be gathered from the description and the appended drawing.

It goes without saying that the features mentioned above and those still to be explained below can be used not only in the respectively specified combination but also in other combinations or on their own without departing from the scope of the present invention.

### DESCRIPTION OF THE FIGURES

The invention is illustrated schematically in the drawing on the basis of an exemplary embodiment and is described in detail below with reference to the drawing.

In the figures,

FIG. 1 shows a schematic illustration of a processing machine designed as a printing press which is suitable for the method according to the invention, according to a particularly preferred embodiment; and

FIG. 2 shows a schematic illustration of a method proceeding in accordance with a particularly preferred embodiment of the invention.

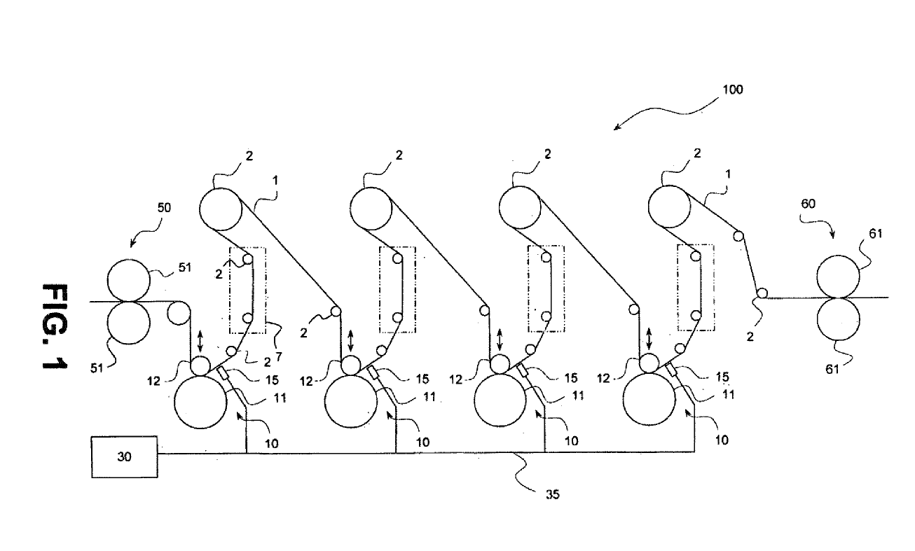

In FIG. 1, a processing machine is illustrated which is implemented as a printing press and which is suitable for carrying out a method according to the invention for the automatic pre-setting or resetting of a register. The printing press is designated overall by 100.

In the illustration, the printing press 100 has four clamping points, formed as printing units 10 here. However, it goes without saying that a greater or smaller number of printing units can also be provided without departing from the invention. The printing units 10 each have printing rolls 11. The printing rolls 11 are in each case provided with a drive, preferably an individual drive (what is known as “shaftless drive technology”), although this is not illustrated in the drawing. The printing press 100 is designed to process a product web 1, a paper web in the present case.

Each printing unit 10 further has an impression roll 12, with which the paper web 1 can be pressed against the printing rolls 11 with high pressure. In the present case, and illustrated by up/down arrows, the impression rolls 12 can be thrown on and off the printing rolls 11, in particular over variable adjustment travels that can be matched to the printing rolls 11, on and off the printing rolls 11.

The printing press here also has clamping points formed as an infeed unit 50 and an outfeed unit 60, which are respectively provided with infeed unit rollers 51 and outfeed unit rollers 61. By means of the infeed and outfeed unit rollers 51, 61, a clamping connection can be produced. Web tension sections can be formed between two clamping points in each case, which are defined by the infeed unit 50, the outfeed unit 60 and/or a printing unit 10.

In the printing press, further driven or non-driven rollers are also provided, which are partly designated in the drawing by 2. In particular, here these can be drying or deflection rollers. By way of example, a drying unit 7 is illustrated in the drawing but, for reasons of clarity, is not explained further.

The printing press illustrated also has sensors 15 which, in particular, can be implemented as optical determining means and/or web tension sensors or force transducers. Via the sensors 15, it is possible in particular to monitor a steady register state and/or web tension state, which is preferably intended to be achieved following the closure of the clamping points. The sensors 15 are connected via a data line 35 to an evaluation and control unit 30.

The unit 30 preferably includes a computing unit for carrying out the method according to the invention. Not illustrated are further channels, via which the evaluation unit 30 performs a register correction, in particular in a cascaded manner according to an advantageous refinement.

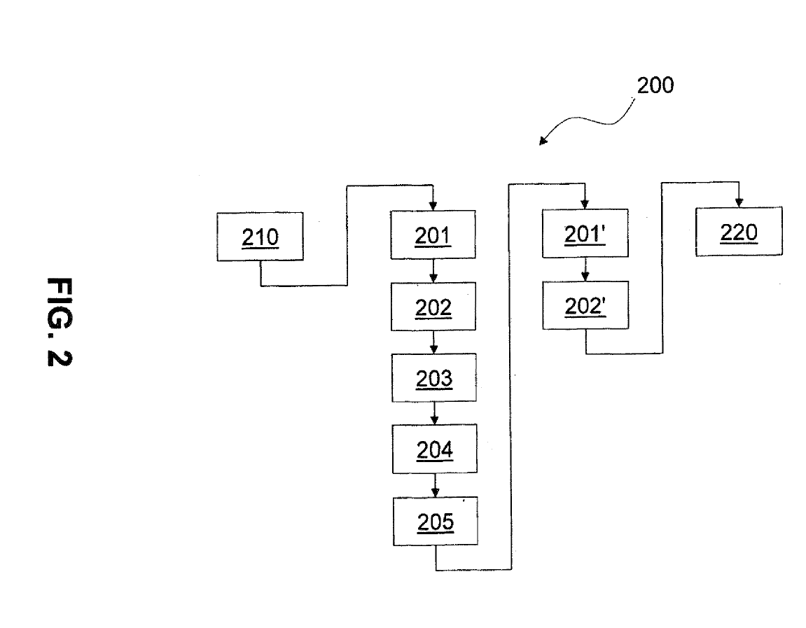

In FIG. 2, a preferred embodiment of a method according to the invention will be described with reference to a flow chart, which is designated 200 overall.

In step 210, the method begins on the basis of an appropriate starting signal or at a specific time.

In step 201, an impression roll of at least one printing unit is thrown on and at least one web tension section is formed. As explained above, however, as a rule in this step all the impression rolls are thrown onto the respective printing rolls and, in addition, other clamping points, such as infeed and/or outfeed unit, are closed. In step 202, a steady web tension and/or a steady register deviation is then effected as quickly as possible. After carrying out step 202, the system can, for example, run in the setup mode for pre-registration. Likewise, there can be normal operation, in which, for example, a large register deviation can be corrected by means of the method according to the invention.

After the steady state has been reached, in step 203 a determination of the respective register deviation for at least one printing unit is carried out by sensors or by a camera. The values determined are kept ready in the system and possibly communicated to a control system or a central unit.

Following this measurement, at least one but, as a rule, all of the downstream impression rolls are thrown off in step 204, a selected printing unit—expediently the first printing unit—remaining closed and serving as a reference, against which the axis correction is carried out.

As a result of the opening of the impression rolls (ideally the smallest possible lifting of the impression rolls in order not to produce any large web tension changes between the printing units as a result of the length change brought about hereby) of the individual printing units, in step 205 rapid, automatic setting of the register can then advantageously be carried out for the individual printing units on the basis of the deviation values previously determined, and is not delayed by the very long compensation processes which are brought about by closed clamping points. Here, the setting is carried out firstly of the on the basis of the deviation of the printing unit itself determined in step 203 and, further, additionally preferably on the basis of a communicated register deviation or communicated actuating value from one or more further printing units. These cascaded actuating values can be acted on by suitable parameters and time elements. The actuating variables for the setting are determined automatically, preferably in a control unit.

After the axis correction has been carried out, in step 201′, the result of which substantially corresponds to step 201, the impression roll/rolls are thrown on again. This throwing-on action can also be carried out simultaneously or successively.

In step 202′, which corresponds substantially to step 202, a steady web tension and/or a steady register deviation is once more effected as quickly as possible, as explained above. As soon as the web tension is constant and the steady state has been reached, a corresponding pre-registration or re-registration has been completed.

This can be notified to the user in step 220 or, for example, an enable signal for further method steps can be provided here.

It goes without saying that only one exemplary embodiment of the invention is illustrated in the figure shown. In addition, any other embodiment is conceivable without departing from the scope of this invention.

### DESIGNATIONS

1 Product web
2 Rollers
7 Dryer
8 Compensator
9 Compensator roller
10 Printing unit
11 Printing roll
12 Impression roll
15 Sensor
30 Evaluation and control unit
35 Data line
50 Infeed unit
51 Infeed unit roller
60 Outfeed unit
61 Outfeed unit roller
100 Processing machine
200 Flow chart
201-220 Method steps

1. A method for automatic axis correction in a processing machine for processing a product web,
wherein the product web is subdividable into at least two web tension sections, a web tension section being delimited by two clamping points formed as transport or processing devices,
wherein an axis deviation of at least one clamping point formed as a processing device is determined, and
the at least one clamping point is then opened, the axis thereof is automatically corrected on the basis of the axis deviation determined and said clamping point is closed after the axis correction.

2. The method as claimed in claim 1, wherein the at least one clamping point is opened during a steady product web transport state.

3. The method as claimed in claim 2, wherein the steady product web transport state is determined by means of monitoring the web tension, and/or by monitoring the axis deviation.

4. The method as claimed in claim 1, wherein in addition in each case an axis deviation of all the clamping points formed as a processing device downstream of the at least one clamping point is determined, the downstream clamping points are opened, the axes thereof are corrected automatically, in each case on the basis of the axis deviation determined, and said clamping points are closed after the axis correction.

5. The method as claimed in claim 1, which is performed for the pre-registration of the processing machine.

6. The method as claimed in claim 5, further comprising the following steps:
clamping the product web in by using a first clamping point and at least one second clamping point in each case formed as a processing device,
determining an axis deviation of the at least one second clamping point,
opening the at least one second clamping point,
automatically correcting the axis of the at least one second clamping point,
clamping the product web in by using the at least one second clamping point.

7. The method as claimed in claim 1, wherein a clamping point for axis correction has applied to it an actuating command which is determined on the basis of the axis deviation determined for the clamping point.

8. The method as claimed in claim 7, wherein the actuating command is additionally determined on the basis of the axis deviation determined for at least one upstream clamping point.

9. The method as claimed in claim 7, wherein the actuating command is cascaded to at least downstream clamping point.

10. The method as claimed in claim 1, wherein the processing machine is constructed as a printing press and the clamping points are formed as infeed units, outfeed units and/or printing units.

11. The method as claimed in claim 10, wherein at least one printing unit has a printing cylinder and an impression roll, the impression roll being arranged at a variable distance from the printing cylinder to open the printing unit.

12. The method as claimed in claim 11, wherein the impression roll is arranged at the first distance as the printing unit is opened for the purpose of axis correction.

13. The method of claim 1, wherein the method is carried out by a computer program having program code means when the computer program is executed on a computer.

14. The method of claim 1, wherein the method is carried out by a computer program product having program code means which are stored on a computer-readable data storage medium when the computer program is executed on a computer.

15. The method as claimed in claim 3, wherein the steady product web transport state is determined by means of measuring or calculating the web tension, and/or by monitoring the axis deviation optically.
